(19) United States
(12) Patent Application Publication
(10) Pub. No.: US 2005/0289057 A1
(43) Pub. Date: Dec. 29, 2005

(54) Information processing system and information processing method

(76) Inventor: Naoya Onizuka, Tokyo (JP)

Correspondence Address: SMITH PATENT OFFICE, 1901 PENNSYLVANIA AVENUE N W, SUITE 901, WASHINGTON, DC, 20006, US

(21) Appl. No.: 10/939,358

(22) Filed: Sep. 14, 2004

(30) Foreign Application Priority Data
Jun. 29, 2004 (JP) 2004-190774

(51) Int. Cl. G06F 17/60

(52) U.S. Cl. 705/44

(57) ABSTRACT

Card handling, which allows anyone to posses a card without any risks emanating from card issuance, may be implemented by establishing a private account for a customer, who is to be given a card, at an associated foreign bank with a high interest rate, issuing, for example, two cards 260 and 270 for the account, depositing in the account a certain amount of money from a domestic bank ATM using each card, allowing withdrawal within a deposited amount given via an ATM in an associated foreign country; and allowing shopping by card in accordance with a predetermined amount within the account balance. As a result, a card usage system, which allows easy possession of a card, shopping using that card, and deposit/withdrawal by multiple cards, is provided.

### BACKGROUND OF THE INVENTION

1. Field of the Invention

The present invention relates to an information processing system and an information processing method, which are characterized by usage of cards via a communication medium.

2. Description of the Related Art

In Japan, due to recent advances in information and communications technology, not through batch processing but credit processing is carried out in real time using a credit terminal connected to a computer or the like of a credit company via a communication medium in credit card transactions.

Furthermore, recently, aside from credit cards, a debit card has emerged and is now available for people to use up to an amount of an overdraft limit plus the credit balance in most cases. This debit card also functions as a cash card and can be used for people to withdraw a deposit.

However, a person must clear a credit check conducted by a financial institution or the like in order to possess a credit card, and, for example, a person without regular work, a foreign worker, a student or the like is unable to have a credit card, and is thus inconvenient.

Furthermore, in the credit card market, there is tough competition due to an increase in newcomers from other industrial systems and overflow of credit card memberships, and deterioration of the revenue environment such as a slump in consumption or increase in personal bankruptcy. Accordingly, new market development is desired by credit card companies and financial institutions.

In addition, when trying to transfer a necessary amount of money to a person in a foreign country, remittance can be made only through necessary procedures via a domestic financial institution, where a large remittance charge is required in this case.

The present invention takes into consideration the above-mentioned issue, and its objective is to provide an information processing system and an information processing method, which allow preparation of two or more cards based on a bank account, realize shopping in domestic and associated company business zones using each card by processing in conjunction with the domestic and associated companies, and implement card handling with a high use value by allowing deposit and withdrawal of a deposit in an established account.

### SUMMARY OF THE INVENTION

The following configuration, for example, is provided as means for reaching this objective and resolving the problems given above. In other words, the present invention provides an information processing system and an information processing method, which allow preparation of two or more cards based on a bank account, realize shopping in domestic and associated company business zones using each card by processing in conjunction with the domestic and associated companies, and implement card handling with a high use value by allowing deposit and withdrawal of a deposit in an established account. The following configuration, for example, is provided as means for reaching such objective.

In other words, an information processing system, which processes card handling by which at least two cards are issued for one account, includes: account establishment means for establishing an account necessary for card use at an associated foreign financial institution; upper limit setting means capable of setting an upper limit for an account deposit for the issued cards; deposit means for authorizing depositing up to the upper limit set by the upper limit setting means in the account using the issued cards and transferring a depositing amount to the account established by the account establishment means; withdrawal authorization means for authorizing withdrawal of a part of the deposit balance of the account using any one of the issued cards; card use authorization means for accepting an inquiry about use of any one of the issued cards from an associated vendor and authorizing card use when a using amount is within a prescribed limit for the account balance; and balance update means for updating the account balance based on use results of the card authorized by the card use authorization means.

Furthermore, an information processing system includes: card issuance means for approving at least two cards in response to a card issuance request from a card issuance requester; account establishment means for establishing an account for the card issuance requester at an associated foreign financial institution; deposit means for transferring a certain amount of money to the associated foreign financial institution and depositing that amount of money in the established account in response to reception of a deposit for the established account; withdrawal authorization means for authorizing withdrawal within the deposit balance of the established account in response to reception of a withdrawal request from the established account using any one of the issued cards; balance update means for updating an account balance of the established account when a certain amount of money has been withdrawn in response to authorization by the withdrawal authorization means; card use authorization means for accepting an inquiry from an inquirer about use authorization of any one of the cards issued by the card issuance means and authorizing card use within a certain limit for the account balance; and using amount transfer means for reducing from the established account balance a card used amount used in accordance with authorization given by the card use authorization means and transferring that amount to the use authorization inquirer.

For example, the foreign financial institution is an institution associated with the card issuer and is in a different country than the card issuer, the withdrawal authorization means authorizes withdrawal of an account deposited amount that is the balance resulting from subtracting an amount for card class, and the card use authorization means authorizes card use of the account deposited amount that is the balance resulting from subtracting an amount for card class.

Furthermore, deposit/withdrawal into/from the account is carried out from an ATM of either the associated foreign financial institution or a domestic financial institution. Still further, the issued cards are respectively held by different person who can individually use the card within a limit for the account balance in accordance with card class.

Moreover, an information processing method for an information processing system, which establishes an account for card use at an associated foreign financial institution and processes card handling by which at least two cards can be issued for one account, comprising the steps of setting an upper limit for an account deposit for the issued cards; authorizing depositing up to the upper limit set in the account using the issued cards and transferring a depositing amount to the established account; authorizing withdrawal of a part of the deposit balance of the account using any one of the issued cards; and authorizing card use in response to reception of an inquiry about use of any one of the issued cards from an associated vendor and updating the account balance based on use results of the authorized card, if a using amount is within a prescribed limit for the account balance.

Furthermore, an information processing method, comprising the steps of approving issuance of at least two cards in response to a card issuance request from a card issuance requester; instructing an associated foreign financial institution to establish an account for a requester after approval of the card issuance; instructing so as to receive a deposit for the established account, transfer the entire deposited amount to the associated foreign financial institution, and deposit that amount in the established account, and authorizing withdrawal within the balance of the established account in response to reception of a withdrawal request from the established account using any one of the issued cards; updating an account balance of the established account when a certain amount of money has been withdrawn in accordance with the withdrawal authorization; and authorizing card use within the balance of the established account in response to reception of an inquiry from an inquirer about use authorization of any one of the issued cards, reducing from the established account balance a card used amount used in accordance with the authorization, and transferring that amount to the use authorization inquirer.

In addition, according to the embodiment, the information processing method is a method wherein: the foreign financial institution is an institution associated with the card issuer and is in a different country than the card issuer; withdrawal of an account deposited amount that is the balance resulting from subtracting an amount for card class, which is given as a requirement for authorization of the withdrawal, is authorized; and card use for the account deposited amount that is the balance resulting from subtracting an amount for card class, which is given as a requirement for authorization of the card use, is authorized.

Furthermore, deposit/withdrawal into/from the account is carried out from an ATM of either the associated foreign financial institution or a domestic financial institution. Still further, the issued cards are respectively held by different person who can individually use the card within a limit for the account balance in accordance with card class.

As a result, the present invention provides an information processing system and an information processing method, which easily implement shopping using cards that are extremely convenient.

Furthermore, by effectively using cards, even when transferring a necessary amount of money to a related party overseas, quick cash withdrawal is possible even in a foreign country using two cards without the need to pay a foreign remittance charge.

### BRIEF DESCRIPTION OF THE DRAWINGS

FIG. 1 is a block diagram showing an exemplary configuration of an information processing system according to an embodiment of the present invention;

FIG. 2 is a flowchart describing card issuance management according to the embodiment of the present invention; and

FIG. 3 is a flowchart describing card use management according to the embodiment of the present invention.

### DETAILED DESCRIPTION OF THE INVENTION

An embodiment of the present invention is described in detail forthwith while referencing the drawings. The following description is about an example where a parent card and a child card are available for one account. However, the present invention is not limited to the above example; a grandchild card may be further available, and may allow another usage as not being limited to the usage method to be described below.

In the embodiment, a customer who wishes to use cards of an information processing system according to the embodiment requests for card issuance to Bank A, for example. The card division of Bank A that has received this request reviews the details of the customer's application form, verifies whether the required items have been provided, and carries out a simple credit check on that customer.

With the information processing system according to the embodiment, as described in detail later, since a method of only accepting use within an amount of savings in an established account is adopted, card issuance can be easily accepted for a student, a person without regular work, or a foreign worker, who tends to be disadvantageously treated in regards to credit, without the need to increase the threshold. He or she who has received card issuance approval deposits an issuance fee, a first year's fee, and an initial opening deposit.

The card division of Bank A issues cards, sends a notice of establishing an account to a customer management server, which will be described later, creates a file for the customer, and registers customer information. The customer management server requests a foreign bank associated with Bank A to establish an account for the customer. At this time, the entire amount of the deposit from the customer is transferred to the established account at the foreign bank associated with Bank A.

It is preferable that this account is established in a country with a high deposit interest rate for the card user's advantage. Alternatively, it is preferable that that account is established in the country where card use to be later described is anticipated.

Note that with the embodiment, instead of approving issuance of only one card (parent card) for one account as with the conventional method, a second card (child card) or more is issued if desired. Accordingly, by depositing the deposit money using the first card, and giving the second card, for example, to a son who is studying abroad, the overseas student can withdraw cash and shop using that card while being in a foreign country.

Even in this case, as will be described later, since shopping and withdrawing are possible only within a deposited amount, the possessor of the parent card can freely control the amount available to the possessor of the child card, and a high service charge necessary for foreign remittance, for example, becomes unnecessary.

As an application case of the information processing system, it is not limited to the above example; for example, the first card may be kept at the office and the second given to a business traveler, allowing usage of the deposited amount for expenses during the business trip.

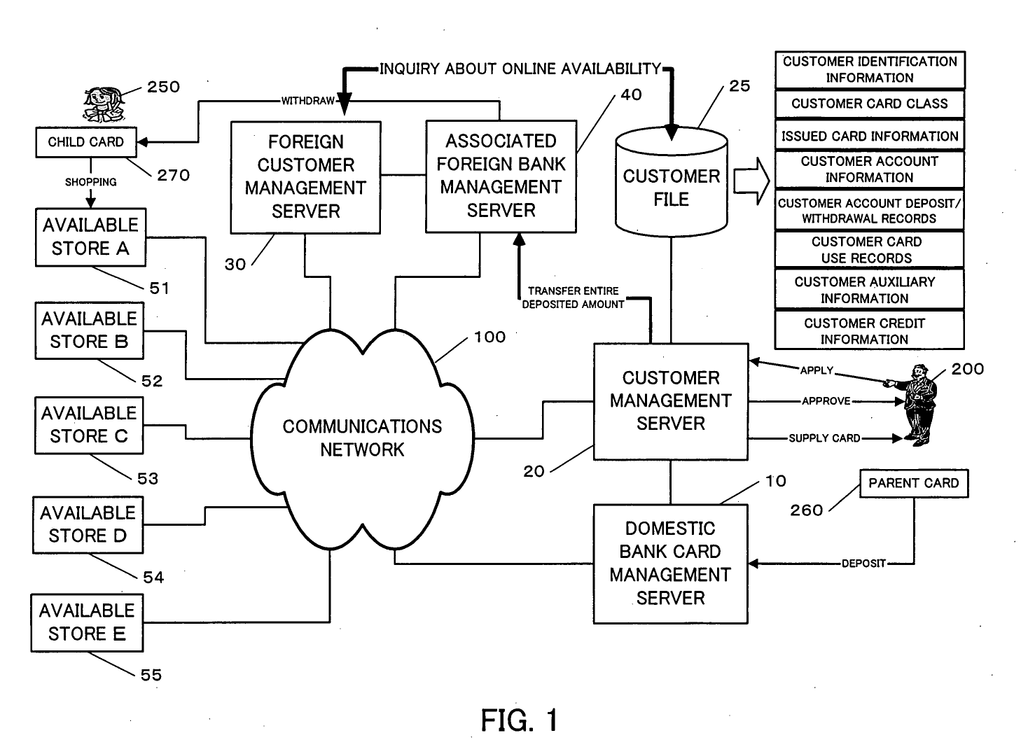

The configuration of a network system used for processing a card transaction according to the embodiment is described forthwith while referencing FIG. 1. FIG. 1 is a block diagram showing the configuration of the network system used for processing a card transaction according to the embodiment of the present invention.

In FIG. 1, a domestic bank card management server 10 is located at a domestic bank card division, which establishes a customer account accompanied by card issuance and manages deposits and withdrawals to and from an account using the issued card (for example, managing a deposit or a withdrawal using an automated teller machine (ATM)), and recognizes the domestic deposit/withdrawal status of issued cards, and sends a notice of the recognized information to a customer management server 20 and a foreign bank card management server 40 of a foreign bank associated with this bank or a foreign customer management server 30.

The customer management server 20 is located at a domestic card division for processing card issuance for customers and managing customer information, and includes a customer file 25, which is for registering customer information. The customer management server 20 further inquires the domestic deposit/withdrawal status of the customer account ascertained by the domestic bank card management server 10 and the associated foreign bank card management server 40, updates customer information according to the inquired results, and then sends a notice of the updated results to the foreign customer management server 30. When there has been a deposit, the entire deposited amount is transferred to that customer account at the associated foreign bank.

The customer file 25 includes, for example, (1) customer identification information, (2) customer card class, (3) issued card information, (4) customer account information, (5) customer account deposit/withdrawal records, (6) customer card utilization records, (7) customer auxiliary information, and (8) customer credit information.

The foreign customer management server 30 is located at a foreign bank associated with a Japanese bank in a foreign country, deposits the transferring amount from the domestic bank card management server 10 to the customer account and determines the available card limit. The foreign customer management server 30 further inquires the deposit/withdrawal status of the account of the associated foreign bank card management server 40, sends the inquired results to the customer management server 20, and reflects the inquired results to the customer file 25.

The associated foreign bank card management server 40 ascertains card use statuses and deposit/ withdrawal statuses at available stores via a communications network 100. Available stores A through E (51 through 55) are stores that allow shopping with cards. With the embodiment, the card may be used not only within Japan, but even at available stores managed by the foreign customer management server 30.

Furthermore, a card applicant 200 possesses, for example, a parent card 260. A possessor 250 possesses a child card 270, or a second card.

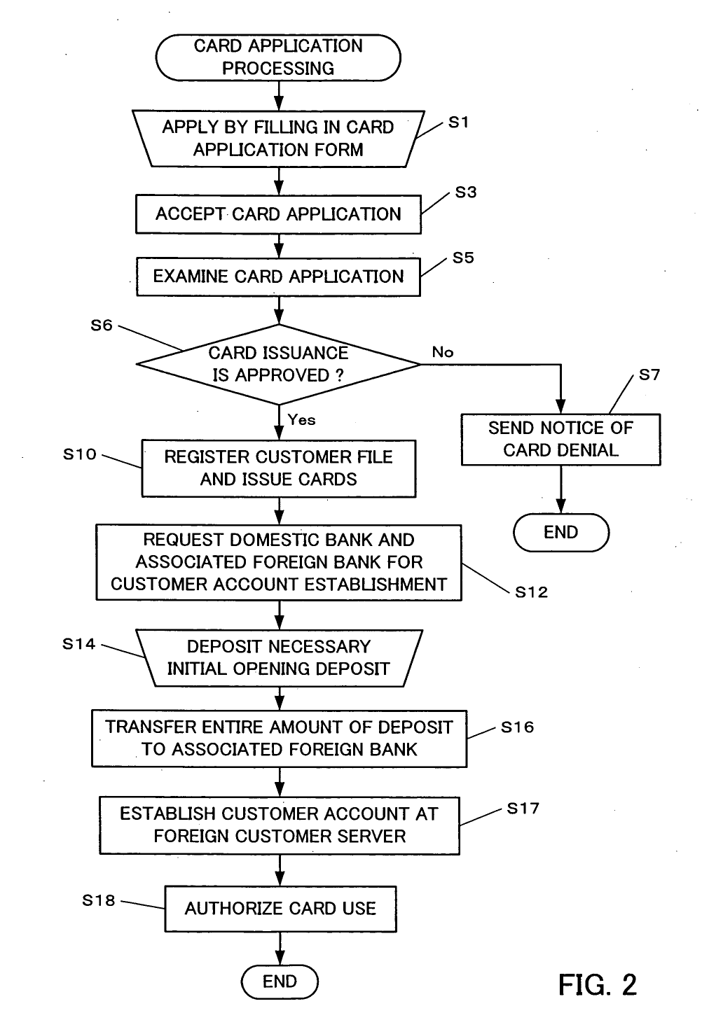

Card handling management according to the embodiment utilizing the information processing system of the embodiment with the above configuration is described forthwith while referencing flowcharts. To begin with, card application processing according to the embodiment is described. FIG. 2 is a flowchart describing card application processing according to the embodiment.

With the embodiment, someone trying to apply for a card goes to an application window in a card management company that issues cards, and as indicated in step S1, to begin with, fills in a card application form, and then follows a card application procedure.

Note that aside from the above-mentioned window, card application may also be accepted via an Internet homepage, for example.

At the card management company that has accepted the card application, the card application is received as indicated in step S3, and examination of the card application is executed in step S5.

The cards according to the embodiment, as described in detail later, use a system of carrying out 100% online verification via the communications network 100, and therefore there is no risk of uncollected receivables. As a result, since there is little necessity of an identification procedure as in the past and a deposit limit is provided, this is a method difficult to use for illicit purposes, and necessary examination is mainly checking formalities and verification of contact information given on the application.

When the investigation is finished, processing proceeds to step S6 and determines whether or not card issuance has been approved, based on the results of the examination of the card in step S5. If card issuance has been denied, processing proceeds to step S7 in which a notice of card denial is then sent to the card applicant, completing this processing. Card issuance is denied mainly when there is missing information from the application or when the applicant is under 18 years old and applying alone.

On the other hand, when card issuance has been approved in step S6, processing proceeds to step S10 and a customer file is then created in accordance with the application. Card issuance of the embodiment is then carried out.

Next in step S12, a notice of establishment of the customer account is sent to a specified domestic bank. More specifically, account establishment is requested online to the domestic bank card management server 10 via the communications network 100 or a dedicated communications medium.

At the same time as accepting a request for account establishment at that domestic bank, customer account establishment is requested at the associated foreign bank. This request is also made online by sending a notice to the associated foreign bank card management server 40 via, for example, the communications network 100. At the associated foreign bank, a notice of customer account establishment is sent to the foreign customer management server 30, which is located at a card company, in response to the request.

Next in step S14, necessary payment (deposit) of an initial card issuance fee, an annual fee, and an initial opening deposit for card issuance is carried out. With the embodiment, multiple card classes are established; for example, three types of cards: ‘Standard Card’, ‘Gold Card’, and ‘Platinum Card’ are typically provided. A ‘Black Card’ is sometimes issued for special members.

For example, for the ‘Standard Card’, the initial card issuance fee is set to 15000 yen, the annual fee to 5000 yen, the minimum amount deposited to 10,000 yen, and a maximum amount deposited to 300,000 yen (an available upper limit amount is 290,000 yen).

For the ‘Gold Card’, the initial card issuance fee is set to 20,000 yen, the annual fee to 10,000 yen, the minimum amount deposited to 20,000 yen, and a maximum amount deposited to 5,000,000 yen (an available upper limit amount is 4,980,000 yen). For the ‘Platinum Card’, the initial card issuance fee is set to 30,000 yen, the annual fee to 20,000 yen, the minimum amount deposited to 50,000 yen, and a maximum amount deposited to 10,000,000 yen (an available upper limit amount is 9,950,000 yen).

For any one of these cards, a parent-and-child card (or a child card) may be issued in response to reception of an application with an issuance fee of 5000 yen and an annual fee of 5000 yen; wherein if multiple cards are issued, different people can use the respective cards.

If the deposit is confirmed, processing proceeds to step S16, the entire amount of deposit is transferred to the customer account established in step S12 at the associated foreign bank. Current deposit interest rates in Japan are extremely low; however, by selecting a bank with a much higher deposit interest rate as an associated foreign bank, the cards can be attractive to the customer.

In step S17, the customer account is then established at the foreign customer management server 30, and card use is authorized for the customer in step S18. Note that application for a parent-and-child card is possible even after card use has begun.

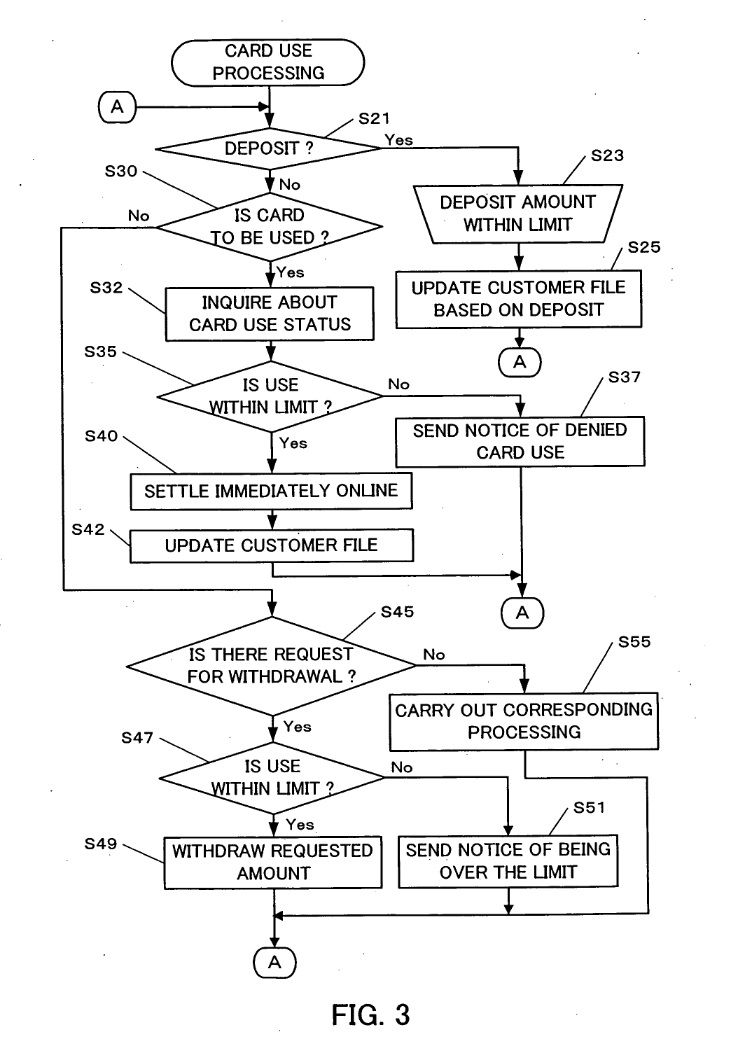

Next; how to handle cards issued as in the above manner is described forthwith while referencing the flowchart of FIG. 3. Actually, processing transfers to the processing of FIG. 3 if use of a card at an available store or a bank is detected; however, the following description includes actions of the customer once card use has begun.

Since the card user can only use the card within the deposited amount, in step S21, card use details sent from the card company are confirmed and whether or not a certain amount of money need to be deposited in the account is determined. In the case of depositing an amount of money, in step S23, for example, a desired amount within the deposit limit is deposited using the card at a window of the domestic bank or a cash dispenser.

Once that amount of money is deposited, deposit information is sent to the customer management server 20 from the domestic bank card management server 10, and in step S25, the customer management server 20 updates the customer file 25 according to the deposit. At the same time, the customer management server 20 sends information to the associated foreign bank card management server 40, thus transferring the entire amount of deposit to the customer account established at the foreign country via a communications medium or the communications network 100. The associated foreign bank card management server 40 sends a notice of the deposit to the foreign customer management server 30. Processing then returns to step S21.

On the other hand, when it is determined in step S21 not to make a deposit, processing proceeds to step S30 and it is determined whether or not to shop at an available store using the issued card. Proceeding to step S32 in the case of using the card, the available amount is examined through a credit inquiry to the foreign customer management server 30 or the customer management server 20 via the communications network 100 from a card terminal of the available store.

In the following step S35, whether use is within the limit is determined. If the use is not within the limit, processing proceeds to step S37 and a notice of card use denials is returned to the card terminal. It is expected that the card terminal regulates shopping using the card within the limit, and requests of payment by cash, for example, for the shortfall.

On the other hand, if card use is within the limit, processing proceeds to step S40 and online debit processing is carried out and the used amount is immediately withdrawn from the customer account. In step S42, the customer management server 20 updates the customer file 25, and processing then returns to step S21.

When it is determined in step S30 that it is not shopping using the card at an available store, processing proceeds to step S45 and it is determined whether or not it is a withdrawal request made using the parent card or the child card at a bank window or a cash dispenser. Proceeding to step S47 if it is a withdrawal request, it is determined whether the requested withdrawal amount is within the aforementioned available limit (amount obtained by subtracting the minimum deposit amount from the deposited amount).

If the withdrawal request is within the limit, processing proceeds to step S49 and the requested amount is withdrawn in accordance with the request. The bank management server 10 that has made the withdrawal sends a notice of the withdrawal to the customer management server 20 and the foreign customer management server 30, and updates the customer file 25. Processing then returns to step S21.

Meanwhile, proceeding to step S51 if the withdrawal request exceeds the limit in step S47, a warning to the effect that the withdrawal exceeds the limit is issued and the withdrawal is denied, and processing then returns to step S21. Subsequently, for example, switching to a withdrawal request that is within the limits may be considered.

Meanwhile, proceeding to step S55 if it is not a withdrawal request in step S45, processing according to the request is carried out, and processing then returns to step S21. For example, if this is a confirmation request for the deposit amount, processing such as sending a notice of the deposit amount at the requested time in response to that request is carried out.

With the information processing system according to the embodiment as described above, since credit processing is not carried out at all for shopping using a card within a deposit limit, conditions allowing issuance of a card can be loosely set.

Furthermore, since not only shopping but also depositing/withdrawing into/from an established account is possible using the parent-and-child card, simply by depositing and withdrawing a certain amount of money between banks at which accounts are established, for example, money deposited in Japan may be received in the Republic of Korea or the United States, where at that time, a remittance charge is unnecessary.

As a result, usage of the card handling system of the embodiment instead of transferring expenses of a business trip abroad or studying abroad to an employee or family can assure the same or more convenience as with the conventional cash transfer method. In this case, even if an annual fee or card issuance fee is required, taking the foreign remittance charge or the like into consideration, as a result, this system can be used at a lower cost. Furthermore, establishment of a company account and giving a child card to the employee going on a business trip abroad allows easy adjustment of business trip expenses and easy management of business expenses even for long-term business trip.

As a result, according to the information processing system of the embodiment, by effectively using the parent-and-child card, cash can be deposited and withdrawn freely in a foreign country in the same way as in Japan, the amount of cash can be easily regulated since card use of more than the deposited amount can be limited, and simple card issuance management and card use with hardly any risk accompanying card issuance are possible.

Therefore, even freelancers, part-time workers without regular work, or foreign workers, who hardly ever receive approval for possession of a card in the past, can relatively easily possess a card.

Furthermore, freely depositing into an account an amount within the limit and withdrawing in accordance with the account balance are possible domestically and internationally if in a servicing area of an associated bank. Moreover, since in this case a high remittance charge is unnecessary and remitting does not require a specified day and time, withdrawal of a deposited amount of money is possible almost simultaneously to deposit into the account.

Even further, differing from the conventional card with which shopping is possible by credit with a line of credit even if the account balance is zero, only shopping and withdrawing within the deposited amount in the account are authorized, and since cash is withdrawn from the account in real time, risks for the card issuing company are reduced without creating bad loans. Furthermore, by depositing the savings into a bank account in a country with high interest rates, further efficient savings are possible compared to the case of making a deposit in a country with low interest rates, thereby providing convenience for the user.

Note that the information processing system and the information processing method according to the present invention are not limited to the application case described above. As a usage method for optimizing the advantages of a deposit card, which can be used to withdraw cash only within a deposited amount, for example, it can be used to manage deposits and withdrawals of a child's monthly allowance, or it may be used as a means for efficiently managing household finances by setting up a fixed limit for the monthly budget.

Furthermore, usage of the card for the information processing system and the information processing method according to the present invention as a corporate card (company parent and child cards) allows the accounting division of a company to settle expenses such as employee's operating expense and purchasing expense. Furthermore, a mail order company, a rental shop, and/ or a certain organization may use the card for settlement services for members or customers.

Moreover, by issuing the card for the information processing system and the information processing method according to the present invention as an OEM card for organizations, the accounting division of a company can use it for settling expenses, or it may be used as a company card. Such organization not only can collect commission income by issuing an original card, but also it brings about a sense of unification of the organization, and may lead to establishment of a brand-name image. As a result, a problem of unpaid bills of a member can be solved, stabilization of organization management is attainable, and at the same time, planning target profits becomes easy.

In addition, a corporation or an organization with clients or customers recruiting users for this card by acting as an agent allows construction of a system by which the basic profits from that user are distributed as commission for the agent.

While the invention has been described with reference to particular embodiments, further modifications and improvements which will occur to those skilled in the art, may be made within the purview of the appended claims, without departing from the scope of the invention in its broader aspect.

1. An information processing system, which processes card handling by which at least two cards are issued for one account, comprising:
account establishment means for establishing an account necessary for card use at an associated foreign financial institution;
upper limit setting means capable of setting an upper limit for an account deposit for said issued cards;
deposit means for authorizing depositing up to the upper limit set by said upper limit setting means in the account using said issued cards and transferring a depositing amount to the account established by said account establishment means;
withdrawal authorization means for authorizing withdrawal of a part of the deposit balance of said account using any one of said issued cards;
card use authorization means for accepting an inquiry about use of any one of said issued cards from an associated vendor and authorizing card use when a using amount is within a prescribed limit for the account balance; and
balance update means for updating said account balance based on use results of the card authorized by said card use authorization means.

2. The information processing system according to claim 1, wherein said foreign financial institution is an institution associated with the card issuer and is in a different country than the card issuer, said withdrawal authorization means authorizes withdrawal of an account deposited amount that is the balance resulting from subtracting an amount for card class, and said card use authorization means authorizes card use of the account deposited amount that is the balance resulting from subtracting an amount for card class.

3. The information processing system according to claim 2, wherein deposit/withdrawal into/from the account is carried out from an ATM of either said associated foreign financial institution or a domestic financial institution.

4. The information processing system according to claim 3, wherein said issued cards are respectively held by different person who is individually capable of using the card within a limit for said account balance in accordance with card class.

5. An information processing system, comprising:
card issuance means for approving at least two cards in response to a card issuance request from a card issuance requester;
account establishment means for establishing an account for the card issuance requester at an associated foreign financial institution;
deposit means for transferring a certain amount of money to said associated foreign financial institution and depositing that amount of money in said established account in response to reception of a deposit for said established account;
withdrawal authorization means for authorizing withdrawal within the deposit balance of said established account in response to reception of a withdrawal request from said established account using any one of said issued cards;
balance update means for updating an account balance of said established account when a certain amount of money has been withdrawn in response to authorization by said withdrawal authorization means;
card use authorization means for accepting an inquiry from an inquirer about use authorization of any one of said cards issued by said card issuance means and authorizing card use within a certain limit for said account balance; and
using amount transfer means for reducing from said established account balance a card used amount used in accordance with authorization given by said card use authorization means and transferring that amount to said use authorization inquirer.

6. The information processing system according to claim 5, wherein said foreign financial institution is an institution associated with the card issuer and is in a different country than the card issuer, said withdrawal authorization means authorizes withdrawal of an account deposited amount that is the balance resulting from subtracting an amount for card class, and said card use authorization means authorizes card use of the account deposited amount that is the balance resulting from subtracting an amount for card class.

7. The information processing system according to claim 6, wherein deposit/withdrawal into/from the account is carried out from an ATM of either said associated foreign financial institution or a domestic financial institution.

8. The information processing system according to claim 7, wherein said issued cards are respectively held by different person who can individually use the card within a limit for said account balance in accordance with card class.

9. An information processing method for an information processing system, which establishes an account for card use at an associated foreign financial institution and processes card handling by which at least two cards can be issued for one account, comprising the steps of:
setting an upper limit for an account deposit for said issued cards;
authorizing depositing up to said upper limit set in the account using said issued cards and transferring a depositing amount to said established account;
authorizing withdrawal of a part of the deposit balance of the account using any one of said issued cards; and
authorizing card use in response to reception of an inquiry about use of any one of said issued cards from an associated vendor and updating the account balance based on use results of the authorized card, if a using amount is within a prescribed limit for the account balance.

10. The information processing method according to claim 9, wherein: said foreign financial institution is an institution associated with the card issuer and is in a different country than the card issuer; withdrawal of an account deposited amount that is the balance resulting from subtracting an amount for card class, which is given as a requirement for authorization of said withdrawal, is authorized; and card use for the account deposited amount that is the balance resulting from subtracting an amount for card class, which is given as a requirement for authorization of said card use, is authorized.

11. The information processing method according to claim 10, wherein deposit/withdrawal into/from the account is carried out from an ATM of either said associated foreign financial institution or a domestic financial institution.

12. The information processing method according to claim 11, wherein said issued cards are respectively held by different person who can individually use the card within a limit for said account balance in accordance with card class.

13. An information processing method, comprising the steps of:
approving issuance of at least two cards in response to a card issuance request from a card issuance requester;
instructing an associated foreign financial institution to establish an account for a requester after approval of said card issuance;
instructing so as to receive a deposit for said established account, transfer the entire deposited amount to said associated foreign financial institution, and deposit that amount in said established account, and authorizing withdrawal within the balance of said established account in response to reception of a withdrawal request from said established account using any one of said issued cards;
updating an account balance of said established account when a certain amount of money has been withdrawn in accordance with said withdrawal authorization; and
authorizing card use within the balance of said established account in response to reception of an inquiry from an inquirer about use authorization of any one of said issued cards, reducing from said established account balance a card used amount used in accordance with the authorization, and transferring that amount to said use authorization inquirer.

14. The information processing method according to claim 13, wherein: said foreign financial institution is an institution associated with the card issuer and is in a different country than the card issuer; withdrawal of an account deposited amount that is the balance resulting from subtracting an amount for card class, which is given as a requirement for authorization of said withdrawal, is authorized; and card use for the account deposited amount that is the balance resulting from subtracting an amount for card class, which is given as a requirement for authorization of said card use, is authorized.

15. The information processing method according to claim 14, wherein deposit/withdrawal into/from the account is carried out from an ATM of either said associated foreign financial institution or a domestic financial institution.

16. The information processing method according to claim 15, wherein said issued cards are respectively held by different person who can individually use the card within a limit for said account balance in accordance with card class.
